(19) United States
(12) Patent Application Publication
(10) Pub. No.: US 2013/0268726 A1
(43) Pub. Date: Oct. 10, 2013

(54) Dual Mode Write Non-Volatile Memory System

(71) Applicants: Xin Guo, San Jose, CA (US); Kiran Pangal, Fremont, CA (US); Paul D. Ruby, Folsom, CA (US); Feng Zhu, San Jose, CA (US)

(72) Inventors: Xin Guo, San Jose, CA (US); Kiran Pangal, Fremont, CA (US); Paul D. Ruby, Folsom, CA (US); Feng Zhu, San Jose, CA (US)

(21) Appl. No.: 13/993,596

(22) PCT Filed: Dec. 30, 2011
(86) PCT No.: PCT/US11/68002

§ 371 Date: Jun. 12, 2013

Related U.S. Application Data
(60) Provisional application No. 61/504,054, filed on Jul. 1, 2011.

(51) Int. Cl. G06F 12/02

(52) U.S. Cl. CPC G06F 12/0246
USPC 711/103

(57) ABSTRACT

Host writes may be handled differently from background writes to non-volatile memory systems. As a result of using different write algorithms for host writes and backgrounds writes, maximum system lifetime and the maximum system performance may be improved in some embodiments.

### BACKGROUND

This relates generally to non-volatile memory systems. Examples of non-volatile memory systems include solid state drives, removable media such as universal serial bus (“USB”) keys, and secure digital (“SD”) cards.

Flash memory systems include one or more NAND memory integrated circuit dice with a controller operated by system firmware. The controller issues write commands to the memory dice that originate from two sources. Host write commands originate from outside the NAND memory system, typically from the host system attached to the memory system. Such writes are commonly issued by a personal computer operating system. In addition, the controller system firmware itself originates background write activities such as wear leveling data relocation, background data refresh, and physical/logical defragmentation operations.

### BRIEF DESCRIPTION OF THE DRAWINGS

Some embodiments are described with respect to the following figures:

FIG. 1 is a schematic depiction of a non-volatile memory system in accordance with one embodiment of the present invention

FIG. 2 is a flowchart for a sequence implemented by the controller shown in FIG. 1 in accordance with one embodiment of the present invention; and

FIG. 3 is a system drawing for one embodiment.

### DETAILED DESCRIPTION

In accordance with some embodiments, host writes may be handled differently from background writes to non-volatile memory systems. As a result of using different write algorithms for host writes and backgrounds writes, maximum system lifetime and the maximum system performances may be improved in some embodiments.

A NAND flash memory system's endurance and reliability may be directly affected by the underlying internal NAND program and erase algorithm and voltages. For example, smaller program voltage steps can improve total sensing margin with tighter cell threshold voltage placement. Lower voltages can reduce that electric stress and charge trap-up.

However, while being better for endurance and reliability, these write algorithms may be slower to execute, leading to slower system performance. As a result, overall system reliability and endurance are often limited or traded off to achieve certain post-performance goals. At advanced lithographic nodes, cell-to-cell interference has become a dominate factor in limiting NAND endurance and reliability as the total sensing margin is reduced due to cell threshold voltage placement broadening, caused by neighboring cell couplings.

It is possible to program the array based on surrounding data patterns to achieve tight threshold voltage placement for better sensing margin. However, such treatments require additional programming operations after the next neighboring page being programmed, which significantly show down host system performance.

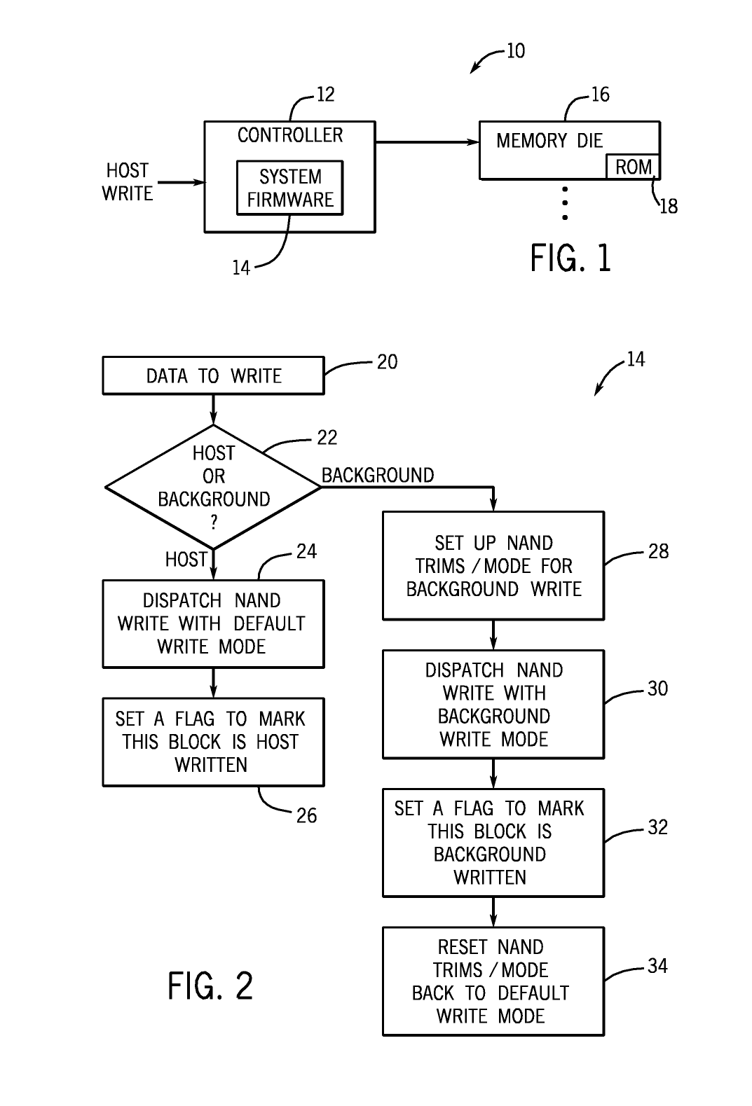

Referring to FIG. 1, a non-volatile memory system 10 may be a solid state drive or a removable medium such as a universal serial bus (“USB”) key, or a secure digital (“SD”) card. The non-volatile memory system 10 may be arranged to receive a host write from a host platform not shown in FIG. 1. The memory system 10 may include a controller 12 and one or more non-volatile memory dice 16 such as NAND flash memory dice, NOR flash memory dice or phase change memory dice to mention a few examples. The controller 12 and the memory dice 16 may be integrated in the same integrated circuit in some embodiments. The controller 12 may execute system firmware 14. Host writes originate from outside the system 10. Background writes generally originate internally from the system firmware 14.

Depending on the write originator, the write algorithm may be switched to improve performance and/or system lifetime in some embodiments. The firmware 14 is necessarily aware of the originator of all media writes before dispatching the write to the memory dice 16. This knowledge of the write originator may be exploited to deploy different internal write algorithms for different types of writes.

In one embodiment, user selectable profiles may be used. The memory dice 16 may have multiple trim profiles stored in an on-chip read only memory (“ROM”) 18 that can be selected through a set feature command at run time to change the internal write algorithm. The trim profiles are control parameters for the internal write algorithm. For example, preset fine placement program steps may be used in one trim profile for background writes and coarse placement program steps may be used in another trim profile for host writes. The firmware 14 selects one of these two profiles at run time by issuing a set feature command to the dice 16 ahead of write dispatch.

In another embodiment, the trims are directly manipulated. The dice 16 internal trims can be directly manipulated at run time through special command interfaces such as a test mode access and set feature mode. Firmware issues these trim changing commands to the dice ahead of write dispatch. This method may have advantages over the user selectable trim profile because it provides more flexibility for actual implementation with the possibility of dynamic management such as cycle-based adjustments. The disadvantage may be added complexity in some embodiments.

In accordance with another manner of setting different modes, hybrid writes with single level cell and multilevel cell modes may be deployed to write host data in high performance and high endurance, single level cell mode, or 1.5 bit-per-cell mode, while background write data with low performance but high endurance two bit-per-cell mode may be used to achieve both high performance and high endurance in the memory system. Then the system deals with the reduced capacity in the foreground mode and switches to different write modes on the fly.

Data-pattern-aware corrective programming modes may be deployed only for background writes to improve endurance and reliability in some embodiments. The dice may have special internal programming modes such as touch up programming and corrective programming that can be used to place a tighter threshold voltage distribution based on surrounding data patterns. However, a large program time downside may result from such a mode that practically prohibits the deployment for host writes even with a cycle-based triggering implementation, since customers may be sensitive to performance degradation over product lifetime. Thus, firmware may be used to turn-on the special programming mode for background writes only at run time in addition to using separately optimized trim to improve system reliability.

Constrained coding that can restrict a neighbor cell's relative threshold voltage differentials in multilevel cell memory arrays may be implemented by the firmware and system hardware to use different coding schemes in writing data to the NAND dice depending on whether it is a host write or a background write. This constrained coding improves the reliability without significantly affecting performance even for background writes. This is because the primary limiter of cell-to-cell interference has already been controlled prior to writing the data pattern to the NAND memory system. The downsides to this approach include requiring separate coding/decoding handling for host written data and system written data. In addition, the system may need to handle both read and write operations according to coding schemes.

Still another approach for optimizing host and background writes is to use proactive background cleanup operations to proactively rewrite the host-written data with more reliable background write algorithms. This may improve system reliability in some embodiments. The firmware may leverage existing background data refresh algorithms to prioritize rewrite of fresh host written data and to manage different refresh schedules based on whether the data is written by the host or other background activities with reliable writes, such as wear leveling data relocation.

Referring to FIG. 2, a sequence 14 may be implemented in software, firmware and/or hardware. In one embodiment the sequence may be implemented as part of the system firmware 14. In software and firmware embodiments the sequence may be implemented as computer executable instructions stored in a non-transitory computer readable medium such as an optical, magnetic or semiconductor in storage. In firmware embodiments, the sequence may be implemented in the integrated circuit that includes a controller 12.

The sequence begins by receiving data to write at block 20. A check at diamond 22 determines whether the originator of the write is the host or the system firmware 14. If it is host originated write, then the write is dispatched as indicated in block 24 with the default write mode. Then the block is flagged as being written by the host as indicated at block 26.

If it is determined in diamond 22 that the write is a background write, then the trims may be set up as described above and the modes set for a background write as indicated on block 28. Then in block 30 the write is dispatched with the background write mode. A flag is set to mark that the block has been background written as indicated in block 32. Then the NAND trims and mode may be set back to the write default mode (i.e. a host originated write) as indicated in block 34.

While an embodiment is described in which the host write mode is the default mode, the background write mode can also be set as the default mode and the trims modified for the host write.

While an embodiment is described in which the host write mode is the default mode, the background write mode can also be set as the default mode and the trims modified for the host write.

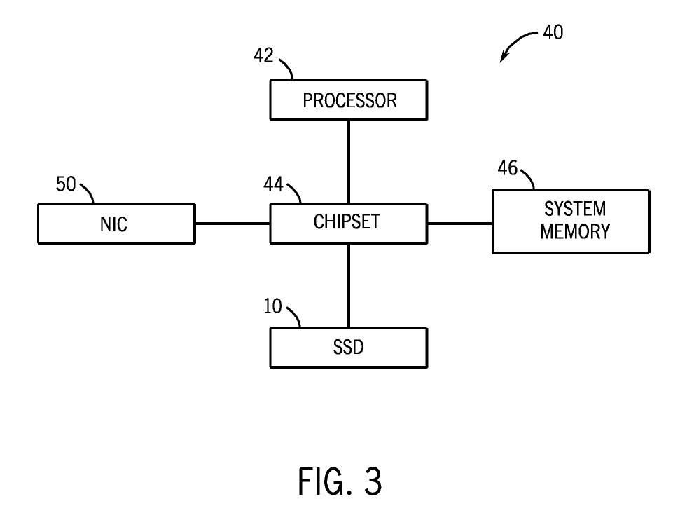

Referring to FIG. 3, a system 40 may be a portable computing device, such as a laptop computer, a tablet computer, or a cellular telephone, or it may be a personal computer, to mention a few examples. System 40 may include a processor 42 coupled to a chipset 44. The chipset 44 may be in turn coupled to a system memory 46 and the solid state drive 10. A network interface card (“NIC”) 50 may be coupled the chipset 44.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying an originator of a write request to non-volatile memory dice; and
writing to the dice differently depending on the originator of the write request.

2. The method of claim 1 including distinguishing host originated writes from other write requests.

3. The method of claim 2 including receiving write requests in a flash memory system.

4. The method of claim 3 including handling writes from outside the flash memory system differently than writes originating within the system.

5. The method of claim 4 including implementing host originated writes differently than background writes.

6. The method of claim 2 including establishing a default mode to implement at least one of host or background writes and when the write request is identified as being other than the default mode, changing the mode to implement the write and then reverting to the default mode after completing the write.

7. The method of claim 6 including changing the mode by changing the trim profile.

8. The method of claim 7 including providing user selectable trim profiles.

9. The method of claim 1 including selecting one of single level or multi-level modes for the default write mode.

10. The method of claim 9 including using one of touch-up programming or corrective programming for background writes.

11. The method of claim 10 including rewriting host written data with the background write algorithm.

12. A non-transitory computer readable storage medium storing instructions to enable a controller to:
identify an originator of a write request to non-volatile memory dice; and
write to the dice differently depending on the originator of the write request.

13. The medium of claim 12 further storing instructions to distinguish host originated writes from other write requests.

14. The medium of claim 13 further storing instructions to handle writes from outside a flash memory system differently than writes originating within the system.

15. The medium of claim 14 further storing instructions to implement host originated writes differently than background writes.

16. The medium of claim 13 further storing instructions to establish a default mode to implement at least one of host or background writes and when the write request is identified as being other than the default mode, change the mode to implement the write and then reverting to the default mode after completing the write.

17. The medium of claim 16 further storing instructions to change the mode by changing the trim profile.

18. The method of claim 17 further storing instructions to provide user selectable trim profiles.

19. The method of claim 12 further storing instructions to select one of single level or multi-level modes for the default write mode.

20. The method of claim 19 further storing instructions to use one of touch-up programming or corrective programming for background writes.

21. An apparatus comprising:
a controller; and
firmware in said controller to identify an originator of a write request to non-volatile memory dice and write to the dice differently depending on the originator of the write request.

22. The apparatus of claim 21 said firmware to distinguish host originated writes from other write requests.

23. The apparatus of claim 22 wherein said controller is a flash memory controller.

24. The apparatus of claim 23 said firmware to handle writes from outside the flash memory controller differently than writes originating within the controller.

25. The apparatus of claim 24 said firmware to implement host originated writes differently than background writes.

26. The apparatus of claim 22 said firmware to establish a default mode to implement at least one of host or background writes and when the write request is identified as being other than the default mode, change the mode to implement the write and then reverting to the default mode after completing the write.

27. The apparatus of claim 26 said firmware to change the mode by changing the trim profile.

28. A system comprises:
a processor;
a solid state drive, coupled to said processor including a controller;
firmware in said controller to identify an originator of a write request to non-volatile memory dice and write to the dice differently depending on the originator of the write request; and
a network interface card coupled to said processor.

29. The system of claim 28, said firmware to select one of single level or multi-level modes for as a default write mode.

30. The system of claim 29, said firmware to use one of touch-up programming or corrective programming for background writes.
